(19) United States
(12) Patent Application Publication
(10) Pub. No.: US 2002/0088663 A1
(43) Pub. Date: Jul. 11, 2002

(54) Theft prevention device for pedal operated vehicles

(76) Inventor: Christopher Cornelius, Los Angeles, CA (US)

Correspondence Address: Jerry H. Noh, 3435 Wilshire Blvd Suite 2716, Los Angeles, CA, 90010, US

(21) Appl. No.: 10/095,559

(22) Filed: Mar. 12, 2002

Related U.S. Application Data
(63) Continuation-in-part of application No. 09/369,292, filed on Aug. 6, 1999, now Pat. No. 6,390,222.

(51) Int. Cl. B60R 25/00

(52) U.S. Cl. 180/287

(57) ABSTRACT

An anti-theft device for a pedal operated vehicles having a pedal lever. The device having a housing member adaptable for mounting within an interior of a vehicle near the pedal lever. The housing member having a first bore in which a rod is positioned to move interchangeably from a retracted position to an extended position to engage and disengage the pedal lever. The movement of the rod being operated by a linear actuator motor connecting thereto. The device further containing a means to lock the rod in the extracted position.

### INTRODUCTION

This application is a continuation in part of application Ser. No. 09/369,292 previously filed on Aug. 6, 1999.

### BACKGROUND

1. Field of Invention

This invention relates to theft prevention devices for vehicles. More particularly, the present invention is an anti-theft device for pedal operated vehicles which operates by locking and preventing the actuation of the pedal.

2. Description of the Prior Art

Vehicle theft is a major problem in the automobile industry. There are many types of anti-theft devices for vehicles. Most cars have ignition locks and steering wheel locks as standard features. Another common anti-theft apparatus is an alarm which makes loud noises to attract attention to a vehicle being entered unlawfully. Alarms are popular options selected by most car owners, and many cars come with an alarm as a standard feature. However, it is possible to circumvent such features as indicated by the high rate of theft for cars having these common devices.

Another popular anti-theft device is an elongated rod for attachment to a steering wheel of a vehicle such as U.S. Pat. No. 5,199,283 issued to Chen commonly known as THE CLUB®, which operates by making steering impossible. Such a device can be circumvented by cutting or removing the steering wheel.

Another form of theft prevention device is a tracking device which can be concealed in an automobiles. When a car is reported stolen, police can activate the tracking signal to locate the car. A disadvantage is that the device does not prevent the car from being stolen in the first place. It only serves as a deterrent to would be car thieves who fear being tracked down by police. However, car thieves who plan to quickly remove parts from a vehicle can simply steal and abandon the vehicle before police can locate them.

There are also theft prevention devices that operate by locking either the gas or brake pedal. Several prior art perform by locking the brakes through offering a means of locking up hydraulic fluid to the wheel cylinders which activate the brakes of a vehicle as exemplified by U.S. Pat. Nos. 4,040,675 and 5,431,487. Others operate by directly placing a locking mechanism around the pedals as exemplified by U.S. Pat. No. 4,493,198 issued to Brown which teaches first and second stop bodies arranged to clamp around the lever of a pedal of a vehicle to prevent actuation of the pedal. Locking mechanisms such as the one taught by Brown can be inconvenient in that a user has to manually reach down under the dashboard to the pedals of the vehicle to attach and remove the devices.

There are a substantial variety of vehicle theft prevention devices in the prior art; however, none teaches an anti-theft device as taught in the present invention.

A primary object of the present invention is to provide a vehicle theft prevention device which is reliable. Another object of the present invention is to provide a vehicle theft prevention device which is easy to operate. It is another objective of the present invention to provide an automobile having a built-in theft prevention device according to the present invention.

### SUMMARY OF THE INVENTION

The present invention is an anti-theft device for a pedal operated vehicles having a pedal lever. The device includes a housing member which can be adapted to be secured to an interior of a vehicle near the pedal lever. The housing member has a first bore in which a rod is positioned to move from a retracted position to an extended position. When the rod is in the extended position, it extends outwardly from the housing member for a predetermined distance and engages the pedal lever.

The movement of the rod to the extended position can be triggered by either air from an air compressor, or by the force of a solenoid located behind the rod. In this embodiment, the housing member contains a means to lock the rod in the extracted position.

In the alternative, the movement of the rod can be controlled by a motor connecting to the rod.

### BRIEF DESCRIPTION OF THE DRAWINGS

FIG. 1 shows the device of the present invention positioned adjacent the pivotal point of pedal lever;

FIG. 2 is a cross sectional side view of the present invention showing the rod in the retracted position;

FIG. 2a is a cross sectional side view of an embodiment of the present invention in the retracted rod;

FIG. 2b is a cross sectional side view of a “lock pin-free” embodiment of the present invention showing the rod in the retracted position;

FIG. 3 is a cross-sectional side view of the present invention showing the rod in the extended position;

FIG. 3a is a cross-sectional side view of an embodiment of the present invention having an extended solenoid positioned behind the extended rod;

FIG. 3b is a “lock pin-free” embodiment of the present invention showing the rod in the extended position;

FIG. 4 is a cross-sectional top view of the present invention;

FIG. 5 is a cross-sectional top view of a second embodiment of the present invention having dual rods;

FIG. 6 is a perspective view of the second embodiment of the present invention; and,

FIG. 6a is a perspective view of the “lock pin-free” embodiment of the present invention.

### DETAILED DESCRIPTION OF THE PREFERRED EMBODIMENT

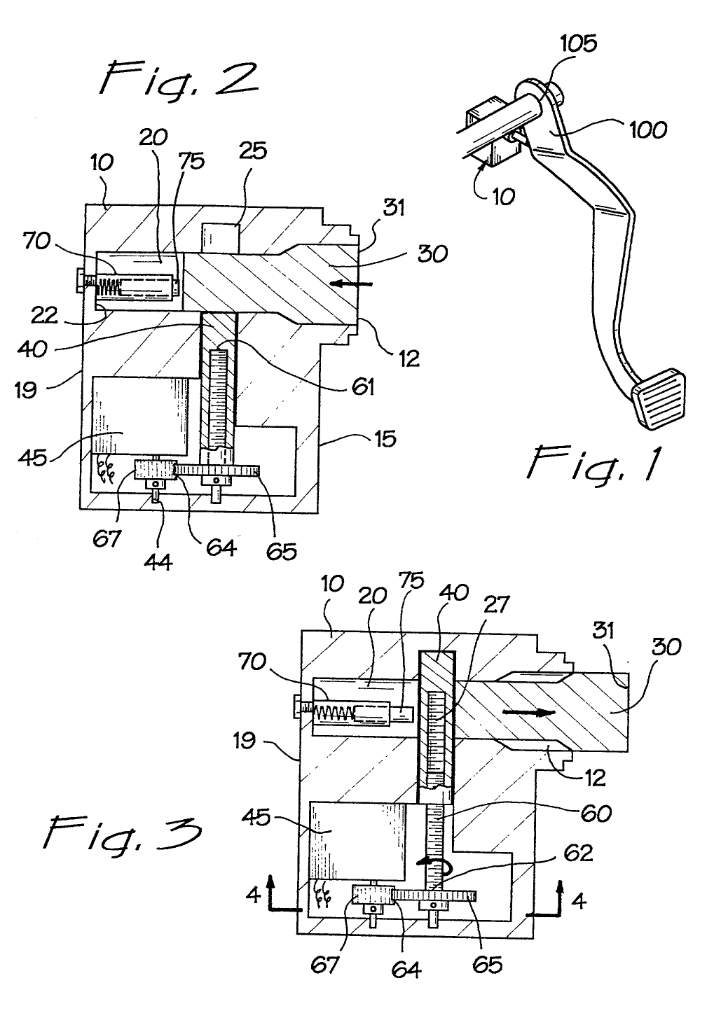

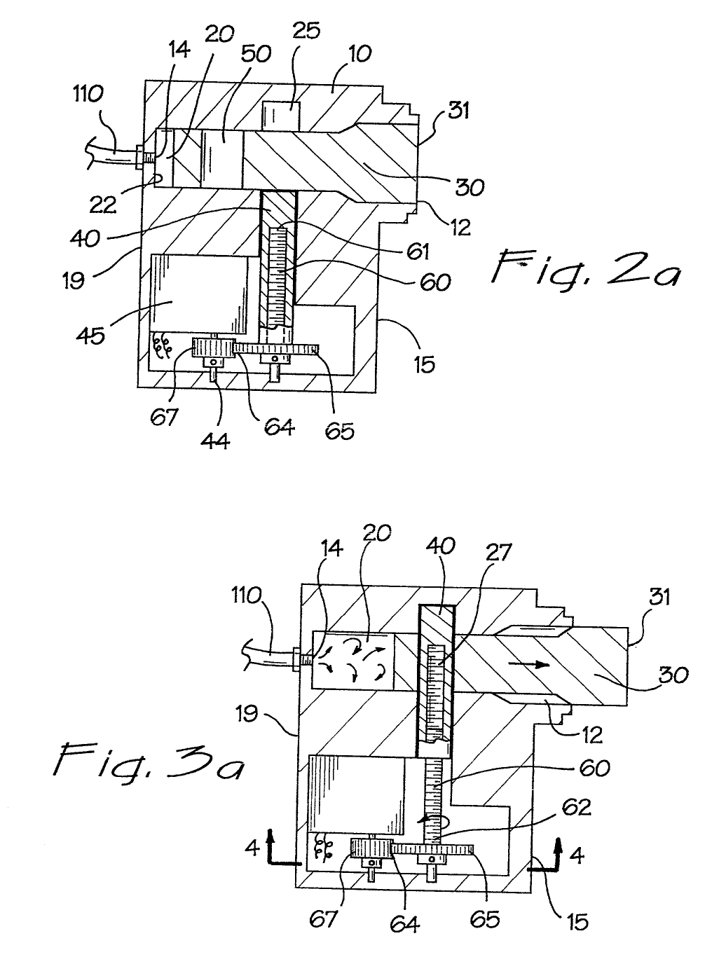

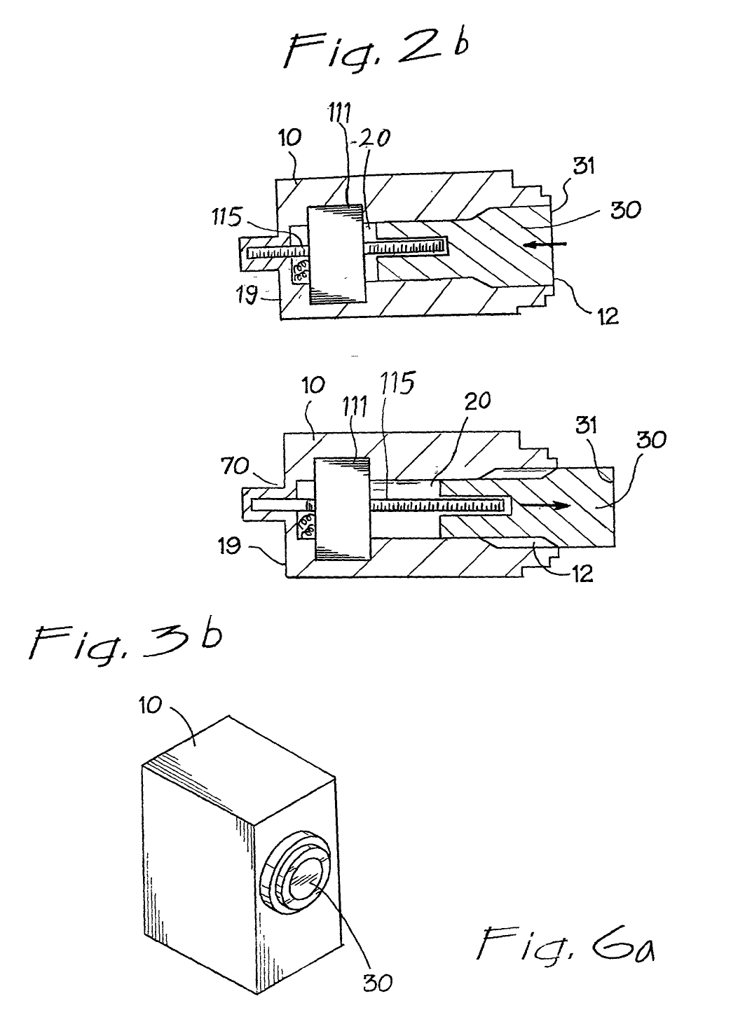

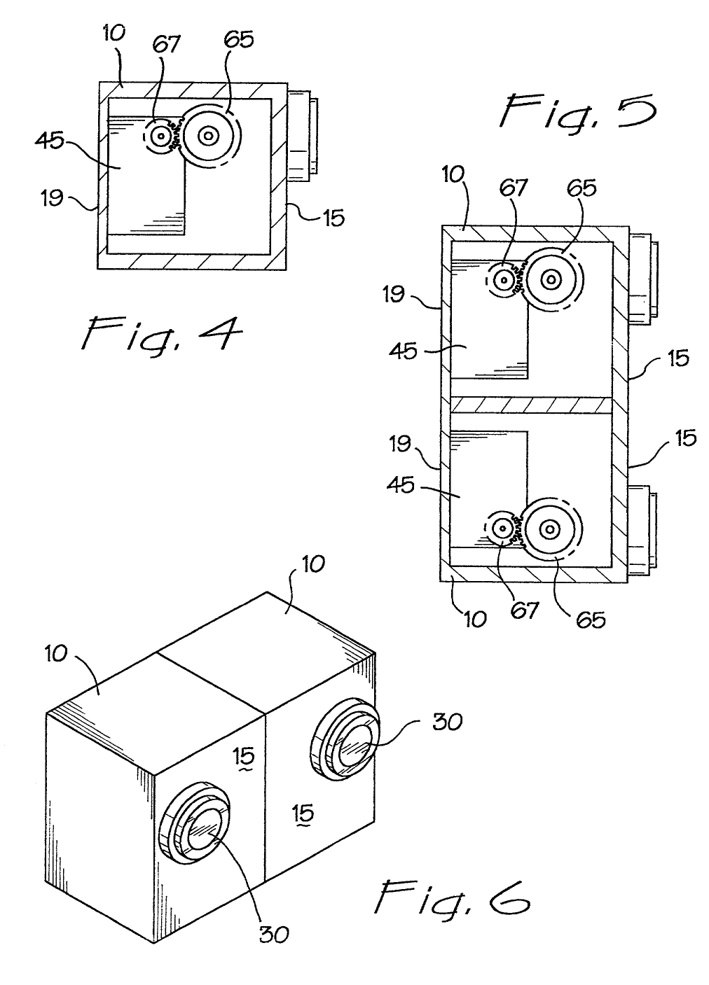

The present invention is an anti-theft device for pedal operated vehicles. An embodiment of the present invention is shown in FIGS. 1-4. The device includes a housing member 10 having a front wall 15 and a back wall 19. The housing member 10 is made of a rigid durable material and has an opening 12 at the front wall 15 leading into a first bore 20 which extends longitudinally to the back wall 19. Situated within the first bore 20 is a rod 30 which is sized and shaped to fit slidably within the first bore 20. The rod 30 has a first end 31 and is movable within the first bore 20 in a piston-like manner from a retracted position as shown in FIG. 2 and FIG. 2a to an extended position as shown in FIG. 3 and FIG. 3a. In the retracted position the rod 30 remains substantially within the first bore 20, and in the extended position the rod 30 extends outwardly from the housing member 10 for a predetermined length.

The rod 30 can be locked in the in the extended position by a pin 40 located within a second bore 25 of the housing member. The second bore 25 crosses the first bore 20 allowing the pin 40 to enter and exit the first bore 20. The pin 40 is movable within the second bore 25 relative to the position of the rod 30 so that when the rod 30 is in the extended armed position, the pin 40 engages the rod 30 to prevent retraction thereof. In the embodiment shown in FIG. 2, 2a, 3, and 3a, a third bore 50 extends across the rod 30. The third bore 50 is located so that when the rod 30 is in the extended position, the third bore 50 aligns with the second bore 25 allowing the pin 40 to enter into the third bore 50.

The movement of the pin 40 is mechanically controlled by an electrical motor 45 having a motor shaft 44. The pin 40 has a threaded hollow bore 27. A shaft 60 having a front end 61 and a base end 62 is threaded to mate with the threaded bore 27 of the pin 40, and thus allowing the shaft 60 to move laterally along the bore 27 of the pin 40. The shaft 60 is connected at its base end 62 to a gear assembly 64. The gear assembly 64 includes a first gear 65 connected to a second gear 67. The second gear 67 has a smaller diameter than the first gear 65. The second gear 67 is attached to the motor shaft 44. The electrical motor 45 can be powered by a battery of a vehicle. FIG. 2, 2a, 3, and 3a show that the pin 40 moves laterally toward the first gear 65 as the shaft 60 rotates in one direction, an that the pin 40 moves laterally away from the first gear 65 as the shaft 60 rotates in a second direction opposite the first direction. In the alternative, the motor can be a linear motor actuator which is available from Eastern Air Devices, Inc. located in Dover N.H. The linear motor actuator will operate the movement of the shaft 60 which in turn will operate the movement of the pin 40.

When used with an automobile, the housing member 10 is secured on the automobile adjacent the back end of the pedal lever 100 beneath the pivotal point 105. At this location, in most cars, the housing member 10 is hidden within a fire wall and not visible in the floor area. The housing member 10 is a positioned with the front wall 15 facing the pedal lever 100 so that when the rod 30 is in the extended position, the first end 31 of the rod 30 engages the pedal lever 100 to limit actuation of the pedal lever 100. As shown in FIG. 3a, the movement of the rod 30 from the retracted position to the extended position is triggered by air pressure supplied by an air compressor source. Many automobiles have an air compressor source as a standard feature. For those cars having an air compressor, a tube 110 is connected at one end to the air compressor, and the other end is connected to a hole 14 located at the back wall 19 of the housing member 10. The hole 14 leads into the first bore 20. For those cars not equipped with an air compressor, one would need to be installed. As an alternative shown, hydraulic pressure instead of air pressure can be used to control the movement of the rod 30 to the extended position.

As shown in FIGS. 2 and FIG. 3, the movement of the rod 30 could be controlled by a solenoid 70 positioned within the first bore 20 behind the rod 30 and attached to a base 22 of the first bore 20. The solenoid 70 has a protruding pin 75, which upon activation, quickly extends and retracts. The activation of the solenoid 70 causes the solenoid in 75 to push against the rod 30 to move the rod 30 from the retracted position to the extended position.

Yet in another “lock pin-free” alternative, shown in FIG. 2b and 3b and 6a, the device includes a housing member 10 having a front wall 15 and a back wall 19 having an opening 12 at the front wall 15 leading into a first bore 20 which extends longitudinally into the housing member 10. Situated within the first bore 20 is a rod 30 which is sized and shaped to fit slidably within the first bore 20. The rod 30 has a first end 31 and is movable within the first bore 20 in a piston-like manner from a retracted position as shown in FIG. 2b to an extended position as shown in FIG. 3b. In the extended position the rod 30 extends further out from the housing member 10 for a predetermined length than when the rod 30 is in the retracted position. In the retracted position, the rod 30 does not have to be completely within said housing but has to retract only a predetermined distance necessary to permit the actuation of the pedal lever. Operating the extension and retraction of the rod 30 is a motor 111 having a shaft connecting to the rod 30. The motor 111 as shown in FIG. 2b and 3b can be a linear motor actuator which is available from Eastern Air Devices, Inc. located in Dover N.H. The linear motor actuator has a threaded screw shaft 115 which with operation of the motor 111 moves in a linear movement within the first bore 20. The screw shaft 115 engages the rod 30 to operate the extending and retracting movement of rod 30.

When used with an automobile, the housing member 10 is secured on the automobile adjacent the back end of the pedal lever 100 beneath the pivotal point 105. At this location, in most cars, the housing member 10 is hidden within a fire wall and not visible in the floor area. The housing member 10 is a positioned with the front wall 15 facing the pedal lever 100 so that when the rod 30 is in the extended position, the first end 31 of the rod 30 engages the pedal lever 100 to limit actuation of the pedal lever 100. As shown in FIG. 3a, the movement of the rod 30 from the retracted position to the extended position is triggered by air pressure supplied by an air compressor source.

The operation of the motors utilized in the present invention requires a power source. The power requirement can be supplied by connection to the existing car battery conventionally found in automobile or an independent battery source.

The operation of the anti-theft device can be controlled by a key switch. When the vehicle is being operated, the anti-theft device is inactivated. In the inactive state, the rod 30 is retracted allowing the driver to freely press down on the pedal lever 100. When the driver parks the vehicle and wants to activate the device (to render the vehicle theft-proof), a key is inserted into the key switch and turned to the “on” position. Turning the switch to the “on” position triggers the air compressor to release air in to the first bore 20 causing the rod 30 to eject to the extended position. Should the device have a solenoid 70 instead of an air compressor, the turning of the switch to the “on” position activates the solenoid 70. The key switch also activates the electrical motor 45 immediately after the rod 30 reaches the extended position. Upon activation, the electrical motor 45 rotates the shaft 60 in the direction which moves the pin 40 laterally away from the gear assembly 64 and into the third bore 50 of the extended rod 30 (FIG. 3a) or behind the extended rod 30 (FIG. 3). When the driver wants to operate the vehicle, the key switch is turned to the “off” slot. Upon rotating the key switch to the “off” position, the electrical motor 45 rotates in the direction which moves the pin 40 laterally toward the gear assembly 64 and out of the third bore 50 (FIG. 2a) or out from behind the rod 30 (FIG. 2). As the driver presses down upon the pedal level, the rod 30 will be pushed back into the retracted position. In the alternative, the electrical motor 45 can be activated and deactivated independently by a second key switch or a key remote device.

In the “lock pin-free” alternative, the operation of the anti-theft device can also be controlled by a key switch. When the vehicle is being operated, the anti-theft device is inactivated. In the inactive state, the rod 30 is retracted enough to allow the driver to freely press down on the pedal lever 100. When the driver parks the vehicle and wants to activate the device (to render the vehicle theft-proof), a key is inserted into the key switch and turned to the “on” position. Turning the switch to the “on” position triggers the movement of the motor to linearly urge the rod 30 to the extended position and engage the pedal lever 100.

For vehicles having a brake pedal and a gas pedal, the device could be installed behind the pedal lever of each of the brake and gas pedal. In the alternative a second embodiment of the device shown in FIGS. 5 and 6 have a second fixedly attached housing member 10. The second embodiment has two rods 30, and the device can be positioned in the vehicle so that upon activation, one rod 30 engages the brake pedal and the other rod 30 engages the gas pedal.

Although a preferred embodiment of the invention has been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claims which follow.

In the claims:

1. An anti-theft device for a pedal operated vehicle having a pedal lever, said device comprising:
a housing member secured to an interior of said vehicle adjacent said pedal lever, said housing member having a front portion and a back portion;
said front portion of said housing member defining an aperture leading into a first bore, said first extending linearly into said housing member;
a rod slideably disposed in said first bore, said rod being slideable interchangeably between a retracted position and an extended position; and,
whereby, when said rod is in said extracted position said rod extends outwardly from said housing member for a predetermined distance and engages said pedal lever to limit actuation of said pedal lever, and when said rod is in said retraced position said rod moves a predetermined distance into said housing member to allow actuation of said pedal lever;
a means to move said rod from said retracted to said extended position.

2. The anti-theft device as described in claim 1 wherein said means to move said rod from said retracted to said extended position is a motor engaged to said housing member, said motor comprising:
a shaft extending from said motor connecting to said rod; and,
said motor operating to provide linear movement to said shaft.

3. The anti-theft device as described in claim 2 wherein said motor is a linear actuator motor and said shaft is a threaded screw shaft.

4. The anti-theft device as described in claim 1 wherein said means to move said rod from said retracted to said extended position comprises:
a hydraulic pump, a tube connecting to said hydraulic pump and leading into said first bore behind said rod; and whereby hydraulic pressure from the pump can be exerted into said first bore via said tube to move said rod from said retracted position to said extended position.

5. An anti-theft device for a pedal operated vehicle having a pedal lever, said device comprising:
a housing member secured to an interior of said vehicle adjacent said pedal lever, said housing member having a front portion and a back portion;
said front portion defining an aperture leading into a bore, said bore extending linearly into said housing member;
a rod slideably disposed in said bore to move interchangeably between a retracted position and an extended position;
whereby, when said rod is in said extracted position said rod extends outwardly from said housing member for a predetermined distance and engages said pedal lever to limit actuation of said pedal lever, and when said rod is in said retraced position said rod moves a predetermined distance into said housing member to allow actuation of said pedal lever;
a motor engaged to said housing member, said motor comprising a shaft extending from said motor connecting to said rod; and,
said motor operating to provide linear movement to said shaft.

6. The anti-theft device as described in claim 5 wherein said motor is a linear actuator motor and said shaft is a threaded screw shaft.

7. In an automobile having at least one pedal lever for controlling the movement of said vehicle, the improvement comprising:
a housing member secured to an interior of said vehicle adjacent each pedal lever, said housing member having a front portion and a back portion;
said front portion defining an aperture leading into a first bore, said first extending linearly into said housing member;
a rod slideably disposed in said first bore, said rod being slideable interchangeably between a retracted position and an extended position; and,
whereby, when said rod is in said extracted position said rod extends outwardly from said housing member for a predetermined distance and engages said pedal lever to limit actuation of said pedal lever, and when said rod is in said retraced position said rod moves a predetermined distance into said housing member to allow actuation of said pedal lever;
a means to move said rod from said retracted to said extended position.

8. The automobile as described in claim 7 wherein said means to move said rod from said retracted to said extended position is a motor engaged to said housing member, said motor comprising:
a shaft extending from said motor connecting to said rod; and,
said motor operating to provide linear movement to said shaft.

9. The automobile as described in claim 8 wherein said motor is a linear actuator motor and said shaft is a threaded screw shaft.

10. The automobile as described in claim 7 wherein said means to move said rod from said retracted to said extended position comprises:
a hydraulic pump, a tube connecting to said hydraulic pump and leading into said first bore behind said rod; and whereby hydraulic pressure from the pump can be exerted into said first bore via said tube to move said rod from said retracted position to said extended position.

11. In an automobile having at least one pedal lever for controlling the movement of said vehicle, the improvement comprising:
a housing member secured to an interior of said vehicle adjacent each said pedal lever, said housing member having a front portion and a back portion;
said front portion defining an aperture leading into a bore, said bore extending linearly into said housing member;
a rod slideably disposed in said bore to move interchangeably between a retracted position and an extended position;
whereby, when said rod is in said extracted position said rod extends outwardly from said housing member for a predetermined distance and engages said pedal lever to limit actuation of said pedal lever, and when said rod is in said retraced position said rod moves a predetermined distance into said housing member to allow actuation of said pedal lever;
a motor engaged to said housing member, said motor comprising a shaft extending from said motor connecting to said rod; and,
said motor operating to provide linear movement to said shaft.

12. The anti-theft device as described in claim 11 wherein said motor is a linear actuator motor and said shaft is a threaded screw shaft.
